(19) United States
(12) Patent Application Publication
(10) Pub. No.: US 2003/0226746 A1
(43) Pub. Date: Dec. 11, 2003

(54) Switch casing assembly for ceiling fan

(76) Inventor: Chun Ya Tai, Taichung City (TW)

Correspondence Address: CHARLES E. BAXLEY, ESQUIRE, Hart, Baxley, Daniels & Holton, Fifth Floor, 59 John Street, New York, NY, 10038, US

(21) Appl. No.: 10/163,117

(22) Filed: Jun. 6, 2002

(51) Int. Cl. H01H 9/02

(52) U.S. Cl. 200/293

(57) ABSTRACT

A switch casing assembly of a ceiling fan includes a first part having a first skirt portion extending from the top thereof and a plurality of L-shaped notches are defined in the first skirt portion from a lower periphery of the first skirt portion. A second part has a bottom with a second skirt portion extending from the bottom. A plurality of protrusions extend from an inside of the second skirt portion. The protrusions are engaged with the L-shaped notches so as to connect the two parts.

### FIELD OF THE INVENTION

The present invention relates to a switch casing assembly for a ceiling fan wherein the switch casing comprises two parts and one of which has L-shaped notches and the other has protrusions to be engaged with the L-shaped notches.

### BACKGROUND OF THE INVENTION

A conventional ceiling fan generally includes a switch casing with a motor received therein so as to drive a shaft to which fan blades are connected. The conventional switch casing generally is composed of two parts and one of which is smaller than the other so that the smaller one is engaged with the larger one. Screws are used to penetrate through the walls of the two parts to combine the two parts. Although using screws to connect the two parts of the switch casing is used for a long period of time, it takes a lot of time to position the screws one by one. There are screw head seen from the outer appearance of the switch casing and this affects the aesthetic feature of modern design of the ceiling fans.

The present invention intends to provide a switch casing assembly which does not use any screw and can be assembled quickly.

### SUMMARY OF THE INVENTION

In accordance with one aspect of the present invention, there is provided a switch casing assembly for a ceiling fan and the switch casing comprises a first part and a second part. The first part has a top with a hole defined therethrough and a first skirt portion extends from the top. A plurality of L-shaped notches are defined in the first skirt portion from a lower periphery of the first skirt portion. The second part has a bottom with a hole defined therethrough and a second skirt portion extends from the bottom. A plurality of protrusions extend from an inside of the second skirt portion so as to be engaged with the L-shaped notches to connect the two parts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a bottom perspective view to show the first part of the switch casing of the present invention;

FIG. 2 is a perspective view to show the second part of the switch casing of the present invention;

FIG. 3 is an exploded view to show the two parts of the present invention, and

FIG. 4 is a cross sectional view to show the engagement of the two parts of the present invention.

### DETAILED DESCRIPTION OF THE PREFERRED EMBODIMENT

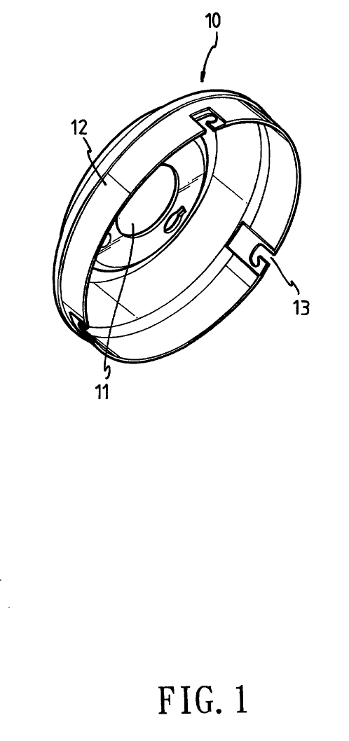

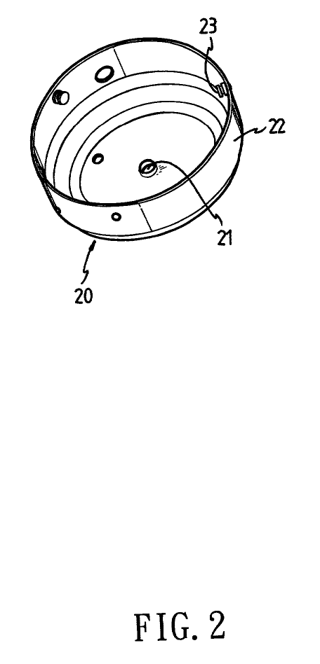

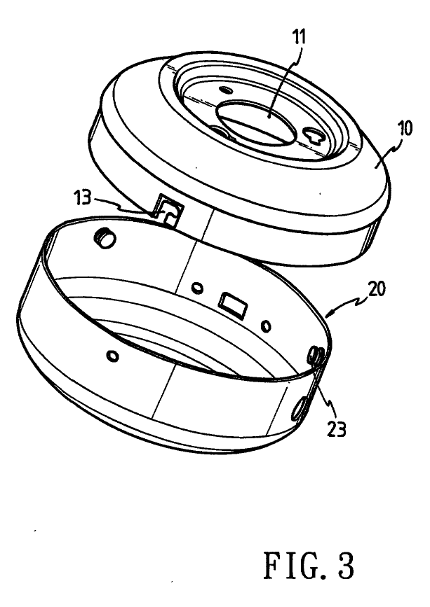

Referring to FIGS. 1 to 3, the switch casing assembly of the present invention comprises a first part 10 that has a top with a hole 11 defined therethrough and a first skirt portion 12 extends from the top. A plurality of L-shaped notches 13 are defined in the first skirt portion 12 from a lower periphery of the first skirt portion 12.

A second part 20 has a bottom with a hole 21 defined therethrough and a second skirt portion 22 extends from the bottom. A plurality of protrusions 23 extend from an inside of the second skirt portion 22.

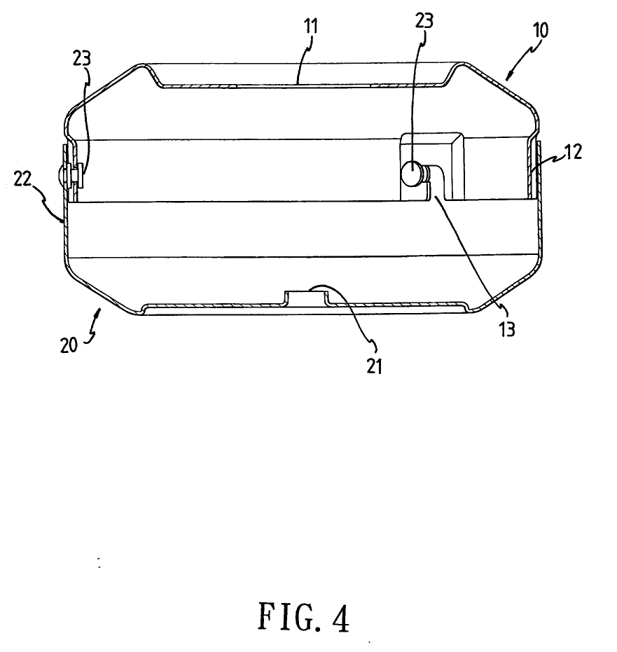

As shown in FIG. 4, the first skirt portion 12 of the first part 10 is engaged with a space enclosed by the second skirt 22 of the second part 20 and the protrusions 23 are engaged with the L-shaped notches 13 from the lower periphery of the first skirt portion 12.

Therefore, for the assemblers, the assembling of the switch casing is easy and convenient simply by matching the two parts 10, 20 and inserting the protrusions 23 in the L-shaped notches 13, and then rotating either one of the two parts 10, 20 to let the protrusions 23 well engaged with the notches 13. There are no screws needed and the assembling process can be completed within a short period of time.

While we have shown and described the embodiment in accordance with the present invention, it should be clear to those skilled in the art that further embodiments may be made without departing from the scope of the present invention.

What is claimed is:

1. A switch casing assembly comprising:
a first part having a top with a hole defined therethrough and a first skirt portion extending from the top, a plurality of L-shaped notches defined in the first skirt portion from a lower periphery of the first skirt portion, and
a second part having a bottom with a hole defined therethrough and a second skirt portion extending from the bottom, a plurality of protrusions extending from an inside of the second skirt portion, the first skirt portion of the first part being engaged with a space enclosed by the second skirt of the second part and the protrusions being engaged with the L-shaped notches.
